(19) United States
(12) Patent Application Publication
(10) Pub. No.: US 2014/0001995 A1
(43) Pub. Date: Jan. 2, 2014

(54) FAN CONTROL CIRCUIT

(71) Applicant: WU ZHOU, Shenzhen (CN)

(72) Inventor: WU ZHOU, Shenzhen (CN)

(21) Appl. No.: 13/678,585

(22) Filed: Nov. 16, 2012

(30) Foreign Application Priority Data
Jun. 27, 2012 (CN) 2012102149134

(51) Int. Cl. H02P 7/06

(52) U.S. Cl. CPC H02P 7/06
USPC 318/471

(57) ABSTRACT

A control circuit for controlling a speed of a fan includes a south bridge chip and an oscillation circuit. The south bridge chip is configured to output a control signal corresponding to a temperature sensed by a temperature sensor. The oscillation circuit is configured to control charge time and discharge time of a capacitor, to output a pulse signal, corresponding to the control signal, to the fan, thereby controlling the speed of the fan.

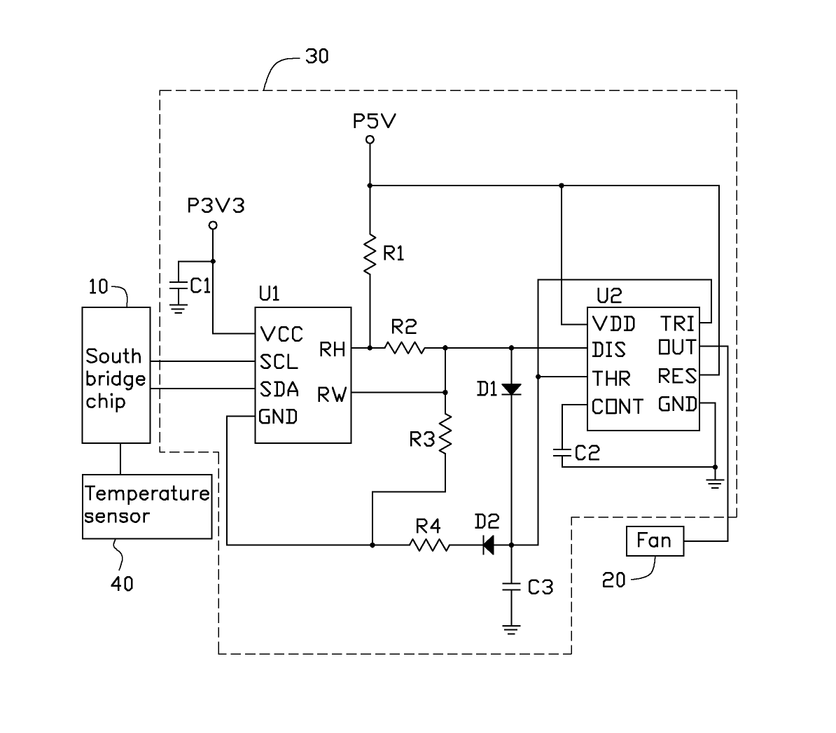

### BACKGROUND

1. Technical Field

The present disclosure relates to a control circuit for a fan.

2. Description of Related Art

In order to efficiently dissipate heat generated by different components in a computer, such as a central processing unit (CPU), a fan is essential. The speed of the fan is controlled by a controller, such as a south bridge chip. The controller enables a monitor chip to output a pulse signal according to detected temperatures of the components, thereby controlling the speed of the fan. However, the monitor chip is costly.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a circuit diagram of an embodiment of a control circuit for a fan of the present disclosure.

### DETAILED DESCRIPTION

The FIGURE illustrates an embodiment of a circuit for controlling operating speed of a fan 20 of the present disclosure. The circuit includes a south bridge chip 10 and an oscillation circuit 30. The south bridge chip 10 is utilized to output a control signal to the oscillation circuit 30 according to a component's temperature sensed by a temperature sensor 40, and the oscillation circuit 30 outputs a pulse signal to the fan 20, thereby controlling the speed of the fan 20.

The oscillation circuit 30 includes a chip resistor such as an ISL90727 digital potentiometer U1, a pulse-generation chip such as a TLC555CDR timer U2, four resistors R1-R4, two diodes D1 and D2, and three capacitors C1-C3.

A power pin VCC of the digital potentiometer U1 is coupled to a power terminal P3V3, and is grounded through the capacitor C1. A first resistance pin RH of the digital potentiometer U1 is coupled to a power terminal P5V through the resistor R1, and coupled to a discharge pin DIS of the timer U2. A second resistance pin RW of the digital potentiometer U1 is coupled to the discharge pin DIS of the timer U2. The discharge pin DIS of the timer U2 is coupled to a cathode of the diode D2 through the resistors R3 and R4 in that order, and coupled to an anode of the diode D1. A cathode of the diode D1 is coupled to an anode of the diode D2, and is grounded through the capacitor C3. A ground pin GND of the digital potentiometer U1 is coupled to a node between the resistors R3 and R4. A clock signal pin SCL and a data signal pin SDA of the digital potentiometer U1 functioning as a system management bus (SMbus) are connected to the south bridge chip 10, to receive a control signal output by the south bridge chip 10. The digital potentiometer U1 has a rated resistance, and is capable of providing two resistances, a first resistance Rp and a second resistance Rd, according to the control signal from the south bridge chip 10. The first resistance Rp is obtained from the first resistance pin RH, and the second resistance Rd is obtained from the second resistance pin RW.

A power pin VDD and a reset pin RES of the timer U2 are coupled to the power terminal P5V. A ground pin GND of the timer U2 is grounded. A trigger pin TRI and a threshold pin THR of the timer U2 are coupled to the anode of the diode D2. A control pin CONT of the timer U2 is grounded through the capacitor C2. An output pin OUT of the timer U2 is connected to the fan 20, to output a pulse signal to the fan 20 according to charge time and discharge time of the capacitor C3, thereby controlling the speed of the fan 20. When the capacitor C3 is charged and exceeds a time T1, the timer U2 outputs a pulse signal with high level, such as logic 1, and when the capacitor C3 is discharged and exceeds a time T2, the timer U2 outputs a pulse signal with low level, such as logic 0, so that the duty cycle of the pulse signal is T1/(T1+T2).

The charging time T1 of the capacitor C3 is (R1+Rp//R2)*C3*1n2, and the discharging time T2 of the capacitor C3 is T2=(R4+Rd//R3)*C3*1n2, where the Rp//R2 stands for a resistance of the first resistance Rp and the resistor R2 connected in parallel, and the Rd//R3 stands for a resistance of the second resistance Rd and the resistor R3 connected in parallel, R1 stands for a resistance of the resistor R1, R4 stands for a resistance of the resistor R4, and C3 stands for a capacitance of the capacitor C3.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control circuit for a fan, comprising:
a south bridge chip configured to output a control signal according to a temperature sensed by a temperature sensor; and
an oscillation circuit configured to receive the control signal, and output a pulse signal to the fan, the oscillation circuit comprising a chip resistor, first to fourth resistors, a first capacitor, and a pulse-generation chip, wherein a power pin of the chip resistor is coupled to a first power terminal, a first resistance pin of the chip resistor is coupled to a second power terminal through the first resistor, and coupled to a discharge pin of the pulse-generation chip through the second resistor, a second resistance pin of the chip resistor is grounded through the third and fourth resistors, and the first capacitor in that order, a trigger pin and a threshold pin of the pulse-generation chip are coupled to a node between the fourth resistor and the first capacitor;
wherein a rated resistance of the chip resistor is divided into two resistances respectively outputted by the first and second resistance pins according to the control signal, to control the charging time and the discharging time of the first capacitor, thereby enabling the pulse-generation chip to output the pulse signal with a duty cycle corresponding to the control signal.

2. The control circuit of the claim 1, wherein the oscillation circuit further comprises a second capacitor, the power pin of the chip resistor is grounded through the second capacitor.

3. The control circuit of claim 1, wherein the south bridge chip outputs the control signal through a system management bus to the chip resistor.

4. The control circuit of claim 3, wherein the chip resistor further comprises a clock signal pin and a data signal pin connected to the south bridge chip, to form the system management bus.

5. The control circuit of claim 1, wherein the oscillation circuit further comprises a first diode, an anode of the first diode is coupled to the trigger pin of the pulse-generation chip and the threshold pin of the pulse-generation chip, a cathode of the first diode is coupled to the third resistor through the fourth resistor.

6. The control circuit of claim 5, wherein the oscillation circuit further comprises a second diode, a cathode of the second diode is coupled to the anode of the first diode, and an anode of the second diode is coupled to the discharge pin of the pulse-generation chip.
